(19) United States
(12) Patent Application Publication
(10) Pub. No.: US 2005/0113069 A1
(43) Pub. Date: May 26, 2005

(54) User authentication through separate communication links

(75) Inventors: Robert C. Knauerhase, Portland, OR (US); Krystof C. Zmudzinski, Forest Grove, OR (US); Abhay A. Dharmadhikari, Beaverton, OR (US)

Correspondence Address: VENABLE, BAETJER, HOWARD AND CIVILETTI, LLP, P.O. BOX 34385, WASHINGTON, DC, 20043-9998, US

(73) Assignee: Intel Corporation, Santa Clara, CA (US)

(21) Appl. No.: 10/720,119

(22) Filed: Nov. 25, 2003

(51) Int. Cl. H04M 1/68; H04M 1/66

(52) U.S. Cl. 455/411; 455/410

(57) ABSTRACT

Authentication from a first independently authenticable communication link may be “transferred” to a second unauthenticable communication link and thereby used for authentication in the second communication link.

### BACKGROUND OF THE INVENTION

Mobile communication devices are becoming increasing popular and commonplace. People rely on these devices, such as mobile telephones and wireless handheld devices (e.g. the Blackberry® handheld, manufactured by Research in Motion) to provide access to important information and communications. These devices use a number of different networks for communication. For example, a mobile telephone may use the general packet radio system (GPRS) cellular network, and a laptop computer may include a radio modem for communication using wireless Internet. Devices that are able to use more than one of these networks are currently being developed and released. Such devices include mobile devices with multiple radios, wherein a single device is able to communicate over a plurality of different networks.

Some of these communication networks are authenticable while others are unauthenticable. Generally, authenticable networks implicitly support authentication in their protocol specifications. That is, it is possible to identify a client device over an authenticable communication network, while over other networks, for example, a wireless Internet connection which may be a dynamic address from, for example, a generic public access hot spot, authentication is not possible.

Furthermore, depending upon environmental conditions and circumstances, as well as the requirements for the communication, it may be desirable to use one of the available networks instead of another. For example, it may be desirable in some circumstances to use the fastest communication network, while it may be desirable in other circumstances to use the least expensive communication network. Currently, there is little to no support for multiply-connected mobile devices.

### BRIEF DESCRIPTION OF THE DRAWINGS

The invention may be understood by referring to the following description and accompanying drawings, wherein like reference numbers generally indicate identical, functionally similar, and/or structurally similar elements.

FIG. 1 illustrates a system according to an embodiment of the invention;

FIG. 2 is a flow chart of a method according to an embodiment of the invention;

FIGS. 3A and 3B illustrate additional embodiments of the present invention; and

FIG. 4 illustrates a system according to an exemplary embodiment of the invention

### DETAILED DESCRIPTION OF EXEMPLARY EMBODIMENTS OF THE PRESENT INVENTION

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

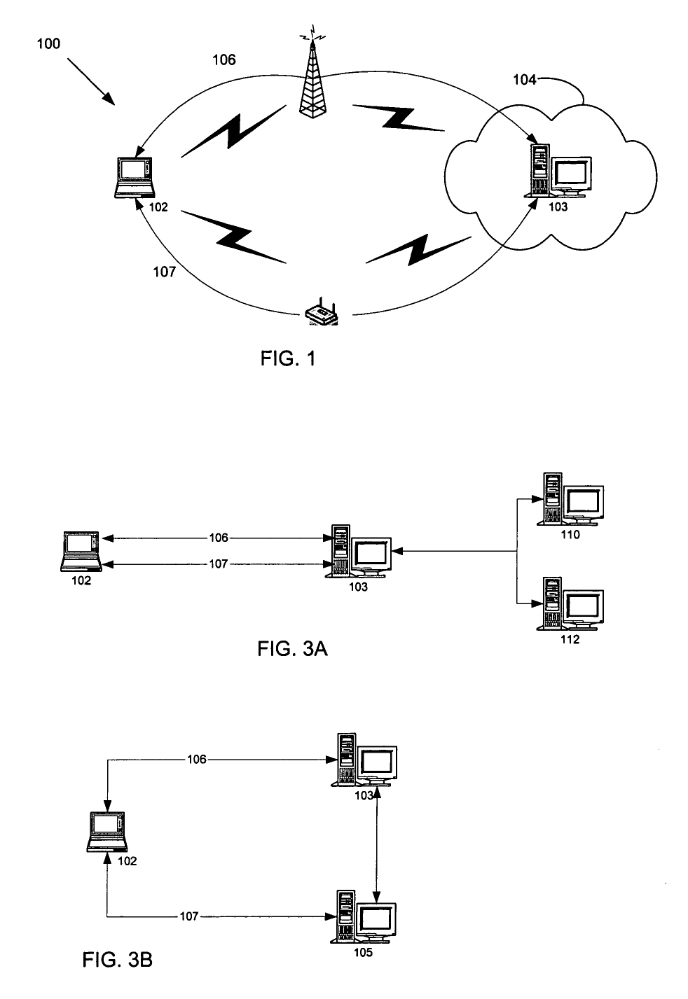

FIG. 1 illustrates a network system 100 according to an exemplary embodiment of the invention. The network system 100 may include a one or more client devices 102 connected via communication links 106, 107 to a server 103, and a larger network 104 having an infrastructure, which may include wired connections. The infrastructure network 104 may include, for example, a LAN (Local Area Network), a WAN (Wide Area Network), an Intranet, or the Internet. The client device may communicate with the server via a plurality of communication links 106, 107. The client device 102 may include multiple radios and network interfaces that may allow it to communicate in multiple communication modes. In one mode, a client device 102 may be able to connect with the server via a first communication link. In another mode, a client device 102 may be able to connect with the server 103 via a second communication link.

The communications links may comprise a wireless communications network. Other suitable embodiments of the communications links, include, but are not limited to: Plain Old Telephone Service (POTS); Public Switched Telephone Network (PSTN); Integrated Services Digital Network (ISDN); Asymmetric Digital Subscriber Lines (ASDL); any of various other types of Digital Subscriber Lines (xDSL); Public Land Mobile Network (PLMN); the Internet; cellular; Global System for Mobile (GSM); General Packet Radio Services (GPRS); Infrared Data Association (IrDA); Cellular Digital Packet Data (CDPD); Enhanced Data Rates for GSM Evolution (EDGE); Universal Mobile Telecommunications System (UMTS); Ricochet proprietary wireless packet network; wireless local loop (WLL); Wireless Local Area Network (WLAN); the IEEE 802.11 standard for Wireless Local Area Networks (WLANs), published Jun. 26, 1997 (the IEEE 802.11 standard is a wireless LAN standard developed by an IEEE (Institute of Electrical and Electronics Engineers) committee in order to specify an “over the air” interface between a wireless client and a base station or access point, as well as among wireless clients); infrared; Bluetooth; Wide Area Network (WAN); Local Area Network (LAN); optical; line of sight; satellite-based systems; cable; User Datagram Protocol (UDP); Specialized Mobile Radio (walkie talkies); any portion of the unlicensed spectrum; wireline networks; and/or any other suitable telecommunications network. Any communications network may be considered to be within the scope of the present invention. The communications links may also be a virtual private network (VPN) or other secure identifiable communication link.

Each client device may include an antenna for transmitting and receiving radio and/or infrared waves, a network interface, and driver software to support connection to the networks. The client devices 102 may include, for example, laptop or desktop computers with wireless modems, network-enabled mobile telephones and Personal Digital Assistants (PDAs).

In an illustrative embodiment, to which the invention is not limited, the client devices may include network interfaces which support communication via a GPRS connection. This GPRS connection may be the first communication link 106. The client devices may also include network interfaces which support the 802.11 standard. A wireless Ethernet connection using the IEEE 802.11 standard may be used for the second communication link 107.

At least one of the plurality of communication links may be authenticable independently from the other communications links. An authenticable communication link may provide an infrastructural way of determining the identity of the client device. Once authenticated, the client device may be allowed access to the appropriate services and features. For example, the client device may be an administrator. Once the administrator identity is established and authenticated, the client device may be allowed access to the administrative functions of the network or to the administrative functions of applications to which the client device is connected over the network. Additionally, authentication may allow for a service provider to bill the appropriate entity for use of the network and the services.

The identity of the client device may be established in a number of different ways. Exactly how the identity is established may depend on the particular client device and communications network being used. A handshaking procedure may be used. A first software module may be provided to perform the handshaking process. For example, the client device may be a cellular telephone that has a GPRS connection, as mentioned above. The GPRS connection may be the first, authenticable communication link. In the GPRS network, the client device may include a subscriber identity module (SIM). The server may authenticate the client device communicating via the GPRS communication link using information from the cellular network derived from the SIM card in the client device. This process may identify the client device for purposes of billing and access control.

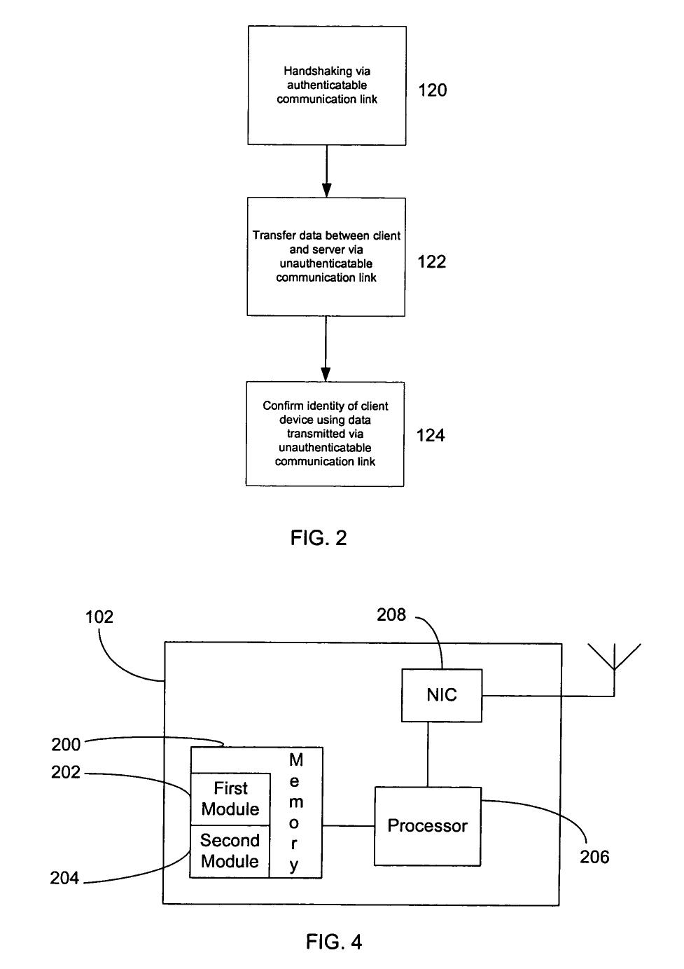

Referring now to FIGS. 1 and 2, a method according to an exemplary embodiment of the invention is described. As mentioned above, the client device 102 may communicate with the server 103 via a plurality of different communication links. Only two such links are shown in FIG. 1; however embodiments of the invention may utilize other numbers of links. The first communication link may be a GPRS cellular network. Such a first communication link thus may be authenticatable, but relatively slow. The second communication link may be a simultaneous wireless Ethernet communication using the IEEE 802.11 standard via an access point or hot spot. Such a wireless Ethernet communication link may not be independently authenticable, but may provide a much faster connection than the GPRS communication. Embodiments of the invention may allow the authentication from the first communication link to be “transferred” to the second communication link. Data may be transmitted and received via the first communication link in order to establish the identity of the client, block 120. Once the identity of the client is established, the second communication link may be used for communication between the client and the server 103 using the identity established over the first communication link, thus providing a fast connection along with the security that comes from strong user authentication. A second software module may be provided to verify the identity of the client device 102 on the “unauthenticable” communications links.

According to an exemplary embodiment of a method, the server 103 may send the client device 102 a nonce over the first communication link. In this context, a nonce is defined as a communication of at least somewhat unpredictable content. For example, the nonce may be, but is not limited to, a random string of numbers of characters. The client device 102 may receive the nonce from the server 103 via the first communication link. The client device 102 may then send the nonce back to the server 103 over the second communication link, block 122. In this embodiment, the identity of the client device 102 will have already been established. The return of the nonce, which was sent to the client device 102 via the first communication link, via the second communication link may be used to prove to a reasonable degree that the communication received at the server 103 via the second communication link is from the same client device 102 that received the nonce via the first communication link. The receipt of the nonce at the server 103 may thus authenticate the identity of the client device 102 communicating with the server 103 via the second communication link, block 124.

The communication links may be made even more secure by using encryption. The nonce sent to the client device 102 may be encrypted so that only the specified client device 102 may decrypt the nonce. Public key encryption may also be used for communicating the nonce between the client device 102 and the server 103. Furthermore, the client device 102 may return the result of a function on the nonce back to the server 103. Thus, a server 103 receiving the nonce it provided to a particular client device 102 may assume communications it receives over different communications links are also from that same client device 102.

Once established, the identity of the client device 102 on the second communication link may be reasonably relied upon as long as the second communication link remains open. If for some reason the second communication link is interrupted, the identity of the client device 102 may no longer be relied upon. A device that was monitoring the communication may have hijacked the connection on the second communication link. The authentication process may then be repeated to reestablish the identity of client device 102.

To provide more certainty in maintaining the identity of the client device 102, a challenge/response procedure may be performed. The server 103 may view the first communication link as an authentication heartbeat and may allow the use of the second communication link only as long as the first communication link is open and functioning. For example, the server 103 may periodically or randomly resend the nonce or another challenge to the client device 102 via the first communication link. The client device 102 may then respond to this challenge via the second communication link. The response to the challenge may include sending a nonce, a function of the nonce, or other data based on the challenge to the server 103. Receipt of the response to the challenge may then verify the identity of the client device 102. If a response to the challenge is not received within a predetermined time period, communication with the client device 102 via the second communication link may be terminated. The process may be useful to prevent connection hijacking by spoofing an IP address.

In another embodiment of the invention, an Ethernet address or some other low level address information may be used for identification of the client device 102 using the second communications link. The identity of the client device 102 may be established via the first authenticable communication link, for example, using the handshaking method and SIM card information as described above. Once the identity of the client device 102 is established, the server 103 may determine the Ethernet address or some other lower level address information for the client device 102. This may be done in a known manner. This same address information may then be included in communications from the client device 102 to the server 103 via another one of the communication links. Since the server 103 has determined the address information of the client device 102, the server 103 knows the identity of that client device 102. Any communications received over other communication links that include the same address information may be determined to also be from that same client device 102. Therefore, the server 103 may treat these communications as being from the client device 102 initially identified.

According to another embodiment of the present invention, security credentials may be used to authenticate the identity of the client device 102. The identity of the client device 102 may be established via the first communications link, for example, using the handshaking method described above. Security credentials, such as a session key, may be sent from the server 103 to the identified client device 102 via the first communication link. The client device 102 may then conduct communications with the server 103 over a second communications link that may not be authenticatable. The communications over the second communications link may include the security credentials. The server 103 may treat the communications that use the security credentials as being from the previously identified client. In an example, the client device 102 may send data it receives to the server 103 via the second, unauthenticated communication link. The data may be encrypted using a session key that was transmitted from the server 103 to the client device 102 via the first communication link. The server 103 may then decrypt the data from the client device 102 using the session key. If the decrypted data is comprehensible, the server 103 may assume that the data was sent using the session key it transmitted to the client device 102 via the first authenticable communication link and may, therefore, assume that the encrypted data was received from the initially identified client device 102.

A client device 102 in the network may act as a gateway between other client devices in a peer-to-peer network and the larger network 104, allowing the other client devices to connect to the infrastructure network. For example, FIG. 3A and FIG. 3B illustrate two different embodiments in which the server 103 may act as a gateway. In FIG. 3A, the server 103 may communicate with the client device 102 via the first authenticable communication link. Once the identity of the client device 102 is established via this communication link, the server 103 may allow the client device 102 to access the different networks 110, 112 at the back end of the server 103. In FIG. 3B, the server 103 may communicate with the client device 102 via the first communication link 106. The server 103 may also communicate with a second server 105. The second server 105 may communicate with the client device 102 via the second communication link 107. The first server 103 may authenticate the identity of the client device 102 via the first authenticable communication link 106. The second server 105 may not be capable of communicating with the client device 102 via an authenticable link such as first communication link 106. Therefore, the second server may not be able to reliably establish an identity of the client device 102. However, the identity of the client device 102 established by the first server 103 may be transferred to the second server 105. For example, the first server 103 may issue a nonce via first communication link 106 to the client device 102 and also inform the second server 105 of the nonce. If the second server 105 receives the nonce or a function of the nonce via the second communication link 107, the second server 105 may reasonably establish the identity of the client device 102. Alternatively, the identity of the client device 102 may be transferred to the second communications link using other methods, such as those described above. The server 103 may directly inform the second server 105 of the identity of the client device 102. The first server 103 and the second server 105 may have a trusted relationship.

FIG. 4 illustrates an apparatus according to an exemplary embodiment of the invention. The apparatus shown and described may be a client device 102, but the description may be equally applicable to a server. The client device 102 may include a computer readable memory 200. A first module 202 and second module 204 may be software programs for performing the process described herein that are stored in memory 200. Processor 206 may communicate with the memory 200 and may execute the software programs stored therein. The processor 206 may also communicate with a network interface card (NIC) 208, which may, in turn receive/transmit signals via an antenna. Other components required for communication are known to those of skill in the art and are omitted for clarity.

Accordingly, embodiments of the invention may allow for the transfer of user/device authentication from one connection to another connection on the same device. The client device and/or the server may determine which of the connections are optimal connections and switch between the connections as necessary. The definition of an optimal connection may vary. In some circumstances the optimal connection may be the fastest connection, the cheapest connection, the lowest-latency connection, or may be based on other criteria or upon combination thereof.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

1. A method, comprising:
a) transmitting and receiving data with a second device via a first communication link to a first device to establish an identity of the first device; and
b) using the established identity for authentication of communications from the first device received by the second device via a second communication link.

2. The method of claim 1, further comprising transferring the established identity to the second communication link.

3. The method of claim 1, further comprising:
sending a nonce to the first device via the first communication link; and
receiving at the second device at least one of the nonce and a function of the nonce from the first device via the second communication link.

4. The method of claim 3, further comprising encrypting the nonce at the second device for the first device.

5. The method of claim 1, further comprising:
receiving a nonce at the first device via the first communication link; and
sending at least one of the nonce and a function of the nonce from the first device via the second communication link.

6. The method of claim 1, further comprising:
determining an optimal communication link from a plurality of communications links between the first device and second device; and
using the established identity for communication between the first device and the second device via the optimal communication link.

7. The method of claim 1, further comprising:
periodically sending a nonce from the second device via the first communication link to the first device; and
maintaining the second communication link with the first device only if a response to the nonce is received from the first device via the second communication link.

8. The method of claim 1, wherein b) comprises:
determining an address of the first device; and
authenticating communications received from the address as being from the first device.

9. The method of claim 1, wherein b) comprises:
transmitting security credentials from the second device to the first device via the first communications link; and
identifying communications that utilize the security credentials received at the second device over the second communications link as being from the same first device.

10. The method of claim 9, further comprising:
receiving the security credentials at the first device;
encrypting data using the security credentials; and
sending the encrypted data via the second communications link.

11. The method of claim 9, further comprising decrypting encrypted data received via the second communications link at the second device in order to identify the first device.

12. A machine readable medium that provides instructions, when executed by a computing platform, cause said computing platform to perform operations comprising a method of:
transmitting and receiving data with a server via a first communication link to a client to establish an identity of the client; and
using the established identity for authentication of communications from the client received by the server via a second communication link between the client and the server.

13. The machine readable medium of claim 12, further comprising instructions, which when executed by a computing platform, cause said computing platform to perform further operations of:
sending a nonce to the client via the first communication link; and
receiving at the server at least one of the nonce and a function of the nonce from the client via the second communication link.

14. The machine readable medium of claim 13, further instructions, which when executed by a computing platform, cause said computing platform to perform further operation of perform encrypting the nonce for the client.

15. The machine readable medium of claim 12, further comprising instructions, which when executed by a computing platform, cause said computing platform to perform further operations of:
determining an optimal communication link from a plurality of communications links between the client and server; and
using the established identity for communication between the client and the server via the optimal communication link.

16. The machine readable medium of claim 12, further instructions, which when executed by a computing platform, cause said computing platform to perform further operations of:
periodically sending a nonce via the first communication link to the client; and
maintaining the second communication link with the client only if a response to the nonce is received from the client via the second communication link.

17. The machine readable medium of claim 12, further comprising instructions, which when executed by a computing platform, cause said computing platform to perform further operations of:
determining an address of the client; and
authenticating communications received from the address as being from the client.

18. The machine readable medium of claim 12, further comprising instructions, which when executed by a computing platform, cause said computing platform to perform further operations of:
transmitting security credentials from the server to a client via the first communications link; and
identifying communications that utilize the security credentials received at the server over the second communications link as being from the same client.

19. The machine readable medium of claim 21, further comprising instructions, which when executed by a computing platform, cause said computing platform to perform further operation of decrypting encrypted data from the client at the server in order to identify the client.

20. An apparatus comprising:
a first module adapted to establish an identity of a client device to a server via at least a first communications link; and
a second module adapted to authenticate the client device on another communications link based on the established identity.

21. The apparatus of claim 20, wherein the first communications links is authenticatable.

22. The apparatus of claim 20, wherein the other communications link is unauthenticatable.

23. The apparatus of claim 20, wherein the second module comprises a driver adapted to send a nonce to the client device via the first communication link and to receive the nonce or a function of the nonce from the client device via the other communication link.

24. The apparatus of claim 23, wherein the second module comprises a second driver adapted to receive a nonce at the client device via the first one of the communication links and to send the nonce or a function of the nonce to the server via the other of the communication link.

25. A machine readable medium that provides instructions, when executed by a computing platform, cause said computing platform to perform operations comprising a method of:
transmitting and receiving data with a client via a first communication link to a server to establish an identity of the client; and
transmitting and receiving data with the client via a second communication link between the client and the server using the established identity.

26. The machine readable medium of claim 25, further comprising instructions, which when executed by a computing platform, cause said computing platform to perform further operations of:
receiving a nonce at the client via the first communication link; and
sending at least one of the nonce and a function of the nonce to the server via the second communication link.

27. The machine readable medium of claim 25, further instructions, which when executed by a computing platform, cause said computing platform to perform further operations of:
periodically receiving at the client a nonce sent via the first communication link from the server; and
sending a response to the nonce from the client to the server via the second communication link.

28. The machine readable medium of claim 25, further instructions, which when executed by a computing platform, cause said computing platform to perform further operations of:
receiving security credentials at the client;
encrypting data at the client using the security credentials; and
sending the encrypted data to the server via the second communications link.
